(19) United States
(12) Patent Application Publication
(10) Pub. No.: US 2019/0061330 A1
(43) Pub. Date: Feb. 28, 2019

(54) ADHESIVE PROPAGATION CONTROL USING LAYERS OF VARIABLE MELT INDEX

(71) Applicant: ENGINEERED FLOORS LLC, Dalton, GA (US)

(72) Inventors: John Joseph Matthews REES, Chattanooga, TN (US); Stephen TSIARKEZOS, Elkton, MD (US); Dimitri ZAFIROGLU, Centreville, DE (US); Anthony DANIELL, Dalton, GA (US)

(21) Appl. No.: 16/113,475

(22) Filed: Aug. 27, 2018

Related U.S. Application Data
(60) Provisional application No. 62/551,545, filed on Aug. 29, 2017.

(51) Int. Cl. B32B 37/12; B32B 27/12; B32B 5/06; B32B 7/02; B32B 7/12; B32B 27/08; B32B 37/10; B32B 37/18; B32B 37/06

(52) U.S. Cl. CPC B32B 37/1207; B32B 27/12; B32B 5/06; B32B 7/02; B32B 7/12; B32B 27/08; B32B 2307/30; B32B 37/182; B32B 37/06; B32B 2037/1223; B32B 2250/04; B32B 2305/18; B32B 37/10

(57) ABSTRACT

Stabilizing a fabric or bonding multiple layers using a multi-layered adhesive layer places an intermediate thermoplastic adhesive between a first layer and a second layer or within the fabric. The intermediate thermoplastic adhesive layer has a plurality of sub-layers with a plurality of melt indexes. Heat and pressure are applied to at least one of the first layer and the second layer or to the fabric to melt the adhesive layer and to achieve a bond between the first layer and the second layer or to stabilize the fabric.

### CROSS REFERENCE TO RELATED APPLICATIONS

The present application claims priority to U.S. Provisional Patent Application No. 62/551,545 filed Aug. 29, 2017, the entire contents of which are incorporated herein by reference.

### TECHNICAL FIELD

Embodiments of the subject matter disclosed herein relate to adhesive bonding and stabilizing of textile sheets and floor coverings

### BACKGROUND

Polymeric thermoplastic layers activated by heat and pressure are commonly used in the textile industry to attach textile layers to other layers including textile layers and non-textile layers. These polymeric thermoplastic layers are also used to secure fibrous elements located between or adjacent the layers. Suitable thermoplastic layers melt at temperatures lower than the melting temperatures of adjacent or surrounding layers or elements. These polymeric thermoplastic layers are also used to stabilize or to reinforce textile fabrics by being placed within the textile fabrics and activated by heat and pressure.

The polymeric thermoplastic layers form molten adhesive upon exposure to heat. This molten adhesive is normally propelled into the adjacent or surrounding layers or fibrous elements by applied pressure. Variable or unequal adhesion to adjacent layers, surrounding layers and fibrous elements occurs when the molten adhesive does not proceed into the adjacent or surrounding layers and fibrous elements in a manner that accommodates the differences in porosity or propensity to adhere.

Yarns, fibers and fiber tufts present within the surrounding or adjacent layers having dissimilar adhesion propensities or different porosities can result in unequal or variable adhesion even if the molten polymer proceeds uniformly into adjacent layers. The final result can be adhesion onto a first layer with little or no adhesion to a second layer.

Attempts at overcoming variable, incomplete or uneven adhesion have in the past used copious amounts of faster-flowing, low-viscosity, high melt flow index (HMI) adhesives. For example, copious amounts of liquid adhesives have been used on the back of a tufted fabric to inundate, envelop and secure the back-laps onto the primary backing with the adhesive, usually also accompanied with the attachment of a secondary backing over the back-laps. For solid thermoplastic adhesives, HMI adhesives proceed into the more porous or more receptive layers or elements when a composite is pressed and heated or re-heated and embossed to create a 3-dimensional effect. Higher amounts of low-viscosity/HMI adhesive may fail to produce sufficient propagation of adhesives into adjacent layers of low permeability or low affinity to adhesion, resulting in a reduction of overall adhesion, and lower final delamination resistance, whereas lower-flowing more viscous lower melt flow index (LMI) adhesives in combination with high pressures and temperatures may achieve stronger overall bonds but can fail to encapsulate the roots of finer textile elements such as yarns or fibers projecting from of looping in and out of an exposed surface. High pressures and temperatures, in combination with high amounts of LMI adhesives may encapsulate finer textile elements but can also result in highly crushed and stiff surfaces or structures.

One attempt at controlling adhesive propagation among the layers of a textile fabric is discussed in U.S. patent application Ser. No. 15/664,876, filed Jul. 31, 2017, which uses non-melting blocking layers adjacent to or surrounded by low-melting adhesive layers to direct the flow of melted adhesives into less receptive or less porous layers or elements. The blocking layers can be impermeable or can be partially permeable or perforated to allow the flow of melted adhesive to bridge across or through the blocking layer and to secure the blocking layer. To achieve satisfactory delamination resistance the use of these blocking layers requires a high degree of adhesive compatibility between the blocking and adhesive layers. Impermeable and incompatible blocking layers must be pre-attached to the adhesive layers and the surrounding layers by mechanical or textile processes such as needle-punching or stich-bonding, adding extra pre-processing steps. Perforated incompatible blocking layers will require a high percentage of open perforated surface to bridge across and secure the layers, and consequently higher amounts of adhesive, also resulting in elevated stiffness, loss of thickness, and an increase in overall cost.

Another limitation of the blocking layers is that, since they do not melt during the adhesion process, they can limit the degree to which a surface or an entire fabric can be three-dimensionally formed during the adhesion process because the blocking layers remain relatively stiff and resist heated formation. This resistance can not only limit the degree of three-dimensional formation but, at the extreme, cause bursting and failing due to the high localized stress during the forming process. Therefore, a process for control of the flow of adhesion that overcomes these limitations is desired.

### SUMMARY

Exemplary embodiments are directed to the use of superposed adhesive sub-layers of HMI and LMI deployed between two layers to be bonded. Alternatively, the superposed adhesive HMI/LMI sub-layers are contained within a textile structure. Upon the application of heat and pressure, the HMI sub-layers activate and move quickly and, as the melted HMI sub-layers are temporarily blocked by the LMI sub-layers, the resulting flow of melted HMI adhesive can be initially directed to proceed into the finer, less receptive or less porous adjacent layers. The LMI sub-layers subsequently soften and eventually reach a low viscosity and proceed into the overall structure as temperature and pressure increase. Therefore, both the fine and less porous or less compatible and the coarser and more-receptive or more compatible adjacent surfaces or elements are secured, and the overall structure is fully inter-bonded. The LMI layers do not flow prematurely into the more porous areas. Moreover, unlike non-melting blocking layers, the LMI sub-layers, once molten, do not resist embossing or other three-dimensional formation.

Exemplary embodiments are directed to a method for adhesively bonding two layers by positioning two thermoplastic adhesive layers between two outer layers, the two thermoplastic adhesive layers at least partially overlapping, initiating conversion of each thermoplastic adhesive layer to molten thermoplastic adhesive at a distinct time using at least one of heat and pressure applied to the outer layers to drive the molten thermoplastic adhesives into at least one of the outer layers and using one of the two thermoplastic adhesive layers to block flow of molten thermoplastic adhesive temporarily.

In one embodiment, positioning the two thermoplastic adhesive layers includes positioning a first thermoplastic adhesive layer and a second thermoplastic adhesive layer between two outer layers, and initiating conversion includes initiating conversion of the first thermoplastic adhesive layer to a first molten thermoplastic adhesive at a first time and initiating conversion of the second thermoplastic adhesive layer to a second molten thermoplastic adhesive at a second time. The second time is distinct from and subsequent to the first time. In addition, using one of the two thermoplastic adhesive layers to block flow includes using the second thermoplastic adhesive layer to block flow of the first molten adhesive from the first time to the second time.

In one embodiment, a blown thermoplastic film is positioned between the two outer layers, and the two thermoplastic adhesive layers are sub-layers in the blown thermoplastic film. In one embodiment, the two thermoplastic adhesive layers have melting points lower than melting points of the two outer layers.

In one embodiment, the two outer layers are a first outer layer with a first molten thermoplastic adhesive permeability and a second outer layer with a second molten thermoplastic adhesive permeability. The first molten thermoplastic adhesive permeability is lower than the second molten thermoplastic adhesive permeability. One of the two thermoplastic adhesive layers is used to block flow of molten thermoplastic adhesive into the second outer layer temporarily. In one embodiment, the two thermoplastic adhesive layers are a first thermoplastic adhesive layer with a first melt index and a second thermoplastic adhesive layer with a second melt index. The first melt index is higher than the second melt index. In one embodiment, the second melt index is less than about 1 g/10 min. In one embodiment, the second melt index is less than 0.5 g/10 min. In one embodiment, the ratio between the first melt index and the second melt index is at least 10/1. In one embodiment, the ratio between the first melt index and the second melt index is at least 5/1.

In one embodiment, the second thermoplastic adhesive layer is used to block flow of molten thermoplastic adhesive from the first thermoplastic adhesive layer temporarily. Suitable thermoplastic adhesive layers include poly-olefin, polyethylene, polypropylene, polyester, ethylene vinyl acetate, co-polyester, polyethylene terephthlate glycol, ethylene methyl acrylate, ethylene acrylic acid, ethylene vinyl acetate, ethylene methyl acrylate with maleic anhydride, ethylene acrylic acid with maleic anhydride, ethylene vinyl acetate with maleic anhydride and combinations thereof.

In one embodiment, a third thermoplastic adhesive layer is positioned between the two outer layers. The three solid thermoplastic adhesive layers overlap, and one of the three thermoplastic adhesive layers is located between two of the thermoplastic adhesive layers. In one embodiment, the second thermoplastic adhesive layer is positioned between the first thermoplastic adhesive layer and the third thermoplastic adhesive layer. The first thermoplastic adhesive layer has a first melt index, and the second thermoplastic adhesive layer has a second melt index. The third thermoplastic adhesive layer has a third melt index, and the second melt index less than the first melt index and the third melt index.

In one embodiment, the two thermoplastic adhesive layers are bonded together before positioning the two thermoplastic adhesive layers between the two outer layers. In one embodiment, pressure is applied to the two outer layers to emboss a three-dimensional pattern into the two outer layers.

Exemplary embodiments are also directed to a method for stabilizing a textile fabric by positioning two thermoplastic adhesive layers, which at least partially overlap, within a textile fabric comprising fibrous elements, initiating conversion of each thermoplastic adhesive layer to molten thermoplastic adhesive at a distinct time using at least one of heat and pressure applied to the textile fabric to drive the molten thermoplastic adhesives through the fibrous elements and using one of the two thermoplastic adhesive layers to block flow of molten thermoplastic adhesive temporarily. In one embodiment, the two thermoplastic adhesive layers each have a melting point and at least one thermoplastic adhesive layer is heat shrinkable at a heat shrink temperature that is lower than the melting point of the at least one solid thermoplastic adhesive.

In one embodiment, a first thermoplastic adhesive layer and a second thermoplastic adhesive layer are positioned within the textile fabric. In addition, conversion of the first thermoplastic adhesive layer to a first molten thermoplastic adhesive is initiated at a first time, and conversion of the second thermoplastic adhesive layer to a second molten thermoplastic adhesive is initiated at a second time. The second time is distinct from and subsequent to the first time. The second thermoplastic adhesive layer is used to block flow of the first molten adhesive from the first time to the second time. In one embodiment, the two thermoplastic adhesive layers include a first thermoplastic adhesive layer and a second thermoplastic adhesive layer, and a third thermoplastic adhesive layer is positioned within the textile fabric such that the second thermoplastic adhesive layer is between the first thermoplastic adhesive layer and the third thermoplastic adhesive layer. The first thermoplastic adhesive layer has a first melt index, and the second thermoplastic adhesive layer has a second melt index. The third thermoplastic adhesive layer has a third melt index, and the first melt index and the third melt index are at least 5 or 10 times greater than the second melt index. In one embodiment, the two thermoplastic adhesive layers are bonded together before positioning the two thermoplastic adhesive layers within the textile fabric.

### BRIEF DESCRIPTION OF THE DRAWINGS

The accompanying drawings, which are incorporated in and constitute a part of the specification, illustrate a plurality of embodiments and, together with the following descriptions, explain these embodiments.

FIG. 1 is a schematic representation of a composite arrangement of two dissimilar outer layers to be bonded using a dual thermoplastic adhesive layer containing comprising two dissimilar adhesive layers;

FIG. 2 is a schematic representation of the composite arrangement of FIG. 1 partially bonded with a first thermoplastic adhesive layer using pressure and heat to activate the first thermoplastic adhesive layer;

FIG. 3 is a schematic representation of the composite arrangement of FIG. 2 after pressure and heat has been applied to activate the second thermoplastic adhesive layer;

FIG. 4 is a schematic representation of a pair of plates for embossing a three-dimensional design on a composite while applying heat and pressure;

FIG. 5 is a schematic representation of the composite arrangement of two dissimilar outer layers to be bonded using a dual thermoplastic adhesive layer with pressure and heat applied by the pair of plates of FIG. 4 to activate the first and second thermoplastic adhesive sublayers;

FIG. 6 is a schematic representation of the composite of FIG. 5 following simultaneous activation of the thermoplastic adhesive and embossing of a three-dimensional pattern;

FIG. 7 is a schematic representation of a composite arrangement of two textile fabrics to be bonded using three thermoplastic adhesive layers;

FIG. 8 is a schematic representation of the composite arrangement of two textile fabrics with the first and third thermoplastic adhesive sublayers activated;

FIG. 9 is a schematic representation of the composite arrangement of two textile fabrics with all thermoplastic adhesive sublayers activated;

FIG. 10 is a schematic representation of a textile fabric containing two internal thermoplastic adhesive layers; and

FIG. 11 is a schematic representation of a textile fabric containing three internal thermoplastic adhesive layers.

### DETAILED DESCRIPTION

The following description of the embodiments refers to the accompanying figures. The same reference numbers in different figures identify the same or similar elements. Reference throughout the whole specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, particular features, structures or characteristics may be combined in any suitable manner in one or more embodiments.

Exemplary embodiments are directed to the bonding of layers using thermoplastic adhesives arranged as a plurality of individual layers or a plurality of sub-layers in a single adhesive layer. Suitable numbers of layers or sub-layers include, but are not limited to, two layers or three layers. In one embodiment, each layer or sub-layer has a different melt index. The “melt index” or “Melt Flow Index” is defined by ASTM Test D1238 as the number of grams per minute of molten polymer forced to flow at a pre-selected temperature at which the polymer melts through an apparatus under a standard pressure defined by the test. In general, the higher the melt flow index the greater the amount of material that will flow over a given period of time. For two different materials having different melt flow indexes, one of the materials, relative to the other material, has a high melt index (HMI), and the other material has a low melt index (LMI). Exemplary embodiments leverage this difference between the LMI and HMI in the materials forming the various adhesive layers.

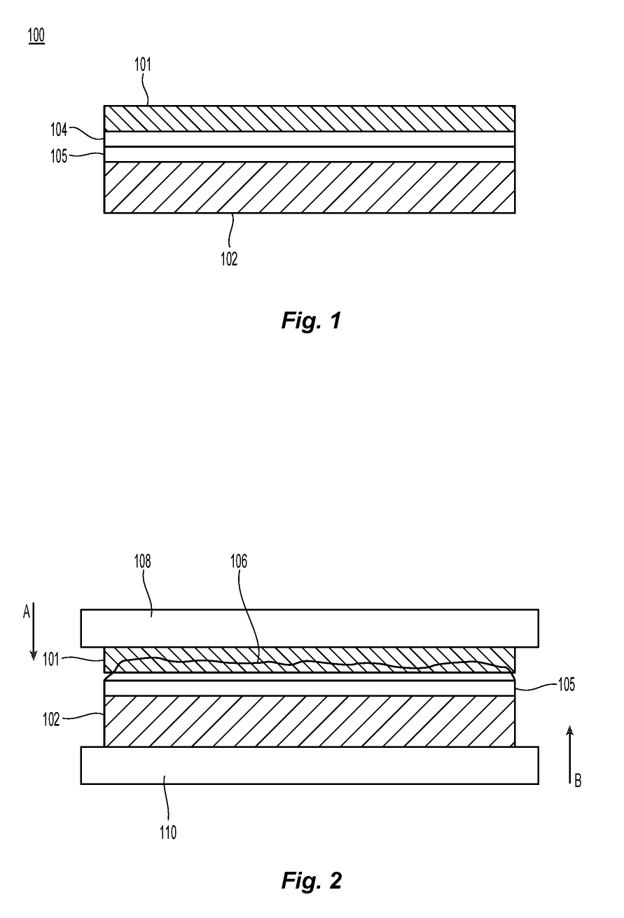

Exemplary embodiments are directed to methods for adhesively bonding two layers using two or more bonding adhesive layers having different melt indexes. In one embodiment, the bonding layers are placed between the layers to be bonded. Referring initially to FIG. 1, a composite 100 is formed by positioning two layers of thermoplastic adhesives, between two outer layers. Suitable outer layers include porous outer layers. The two outer layers are to be bonded together by the thermoplastic adhesives. In one embodiment, the two outer layers include a relatively dense and less receptive first porous layer 101 and more receptive second porous layer 102. In one embodiment, the first porous layer has a first molten thermoplastic adhesive permeability or adhesive compatibility, and the second porous layer has a second molten thermoplastic adhesive permeability or adhesive compatibility. The first molten thermoplastic adhesive permeability or adhesive compatibility is lower than the second molten thermoplastic adhesive permeability or compatibility. Examples of more compatible thermoplastic materials are polyesters, polyamides and polyolefins of higher melting points in the outer layers and lower melting points in the adhesive layers. Examples of less compatible thermoplastic materials are adhesives and outer layers made of different polymers that require higher concentrations, weights and densities of adhesive to achieve a bond.

Positioning the two solid thermoplastic adhesives includes positioning a first solid thermoplastic adhesive 104 and a second solid thermoplastic adhesive 105 between the two outer layers. The two thermoplastic adhesive layers at least partially overlap. Therefore, at least a portion of the space between the outer layers includes two layers of thermoplastic adhesive, and other portions of the space between the outer layers includes only one thermoplastic adhesive or no thermoplastic adhesive. In one embodiment as illustrated, the two thermoplastic adhesive layers completely overlap, filling the space between the two outer layers.

In one embodiment, the first and second thermoplastic adhesive layers can be separate layers individually positioned between the two porous layers. In one embodiment, the two thermoplastic adhesive layers are bonded together before positioning the two thermoplastic adhesive layers between the two outer layers. Alternatively, the first and second thermoplastic adhesive layers are sub-layers in a single thermoplastic adhesive layer that is positioned between the outer layers. In one embodiment, the single thermoplastic adhesive layer containing sublayers of different melt indexes is a blown thermoplastic film that is positioned between the two outer layers. The two thermoplastic adhesive layers are sub-layers in the blown thermoplastic film. In one embodiment, the thermoplastic adhesive layer contains a plurality of sublayers that include more than one layer of the same polymer with the same melt index. All sublayers in the thermoplastic adhesive layer have a melting point temperature lower than the melting point temperatures of the first and second porous layers.

In one embodiment, the first thermoplastic adhesive layer has a first melt index, and the second adhesive layer has a second melt index. The first melt index is higher than the second melt index. Therefore, the first melt index is a HMI, and the second melt index is a LMI. In one embodiment, the second melt index is less than about 1 g/10 min. In one embodiment, the second melt index is less than 0.5 g/10 min. In one embodiment, the ratio between the first melt index and the second melt index is at least 10/1. In one embodiment, the ratio between the first melt index and the second melt index is 5/1. In one embodiment, the HMI first thermoplastic adhesive layer is positioned adjacent the less receptive or less compatible first outer layer having the lower molten thermoplastic adhesive permeability, and the LMI second thermoplastic adhesive layer is positioned adjacent the more receptive or more compatible second outer layer having the higher molten thermoplastic adhesive permeability.

In one embodiment, the two thermoplastic adhesive layers each have a melting point lower than melting points of the two outer layers. Suitable thermoplastic adhesives include, but are not limited to, poly-olefin, polyethylene, polypropylene, polyester, ethylene vinyl acetate, co-polyester, polyethylene terephthlate glycol, ethylene methyl acrylate, ethylene acrylic acid, ethylene vinyl acetate, ethylene methyl acrylate with maleic anhydride, ethylene acrylic acid with maleic anhydride, ethylene vinyl acetate with maleic anhydride and combinations thereof.

Upon application of at least one of heat and pressure, i.e., heat, pressure or both heat and pressure, the first and second thermoplastic adhesive layers form first and second molten thermoplastic adhesives. Normally molten thermoplastic adhesives proceed first or more readily into the more receptive second outer layer having the higher molten thermoplastic adhesive permeability. Using an excess of adhesive weight and increasing heat and pressure to provide sufficient flow of molten adhesive into the less receptive outer layer results in a composite that loses a very high portion of its overall initial height and becomes very stiff.

Therefore, exemplary embodiments of the method for adhesively bonding two porous layers using two or more adhesive bonding layers leverages the different melt indexes of the first and second thermoplastic adhesive layers by taking advantage of the earlier increase of fluidity and decrease in viscosity in a HMI layer to facilitate penetration into a less receptive or less adhesively compatible adjacent layer while being temporarily blocked by a LMI adhesive layer placed against a more receptive or more adhesively compatible adjacent layer. The LMI adhesive layer acts as a blocking layer before the LMI layer itself also reaches lower viscosity and higher fluidity and proceeds into the more receptive or compatible adjacent layer.

Referring now to FIG. 2, in one embodiment, the composite is placed between a first flat plate 108 and a second flat plate 110. In one embodiment, only the first flat plate is a heated plate. In another embodiment, the first flat plate and the second flat plate are heated plates. For example, the second flat plate may be at a lower temperature than the first plate. Heat and pressure are applied to the composite in the direction of arrow A to the first porous layer 101 using the first flat plate 108 and in the direction of arrow B to the second outer layer 102 using the second flat plate. Conversion of the first thermoplastic adhesive to a first molten thermoplastic adhesive 106 is initiated at a first time. The first molten thermoplastic adhesive propagates under pressure a distance into the first porous layer. The second solid thermoplastic adhesive blocks flow of molten thermoplastic adhesive, i.e., the first molten thermoplastic adhesive, into the second porous layer temporarily.

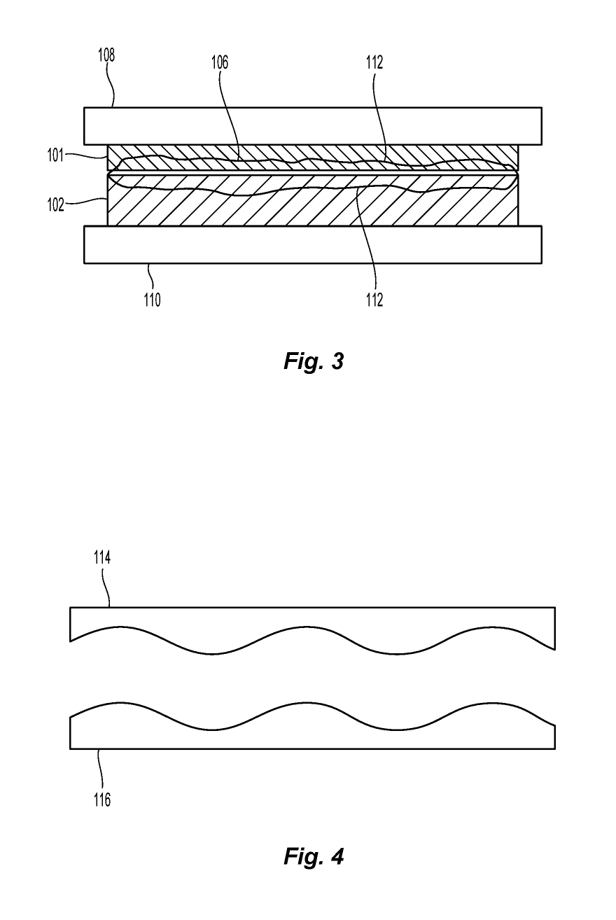

Referring now to FIG. 3, the application of heat and pressure on the composite of FIG. 2 is continued, and conversion of the second thermoplastic adhesive to a second molten thermoplastic adhesive 112 is initiated at a second time. Therefore, the second thermoplastic adhesive layer temporarily blocks, or postpones, the flow of the first molten adhesive from the first time to the second time. Upon initiation of the conversion of the second thermoplastic adhesive to the second molten thermoplastic adhesive, the second molten thermoplastic adhesive flows a distance into the second outer layer, the first outer layer, or both the second outer layer and the first outer layer. In one embodiment, the first molten thermoplastic adhesive also flows a distance into the second porous outer layer. In one embodiment, the first molten thermoplastic adhesive flows a greater distance into the first outer layer than the second molten thermoplastic adhesive.

Exemplary embodiments use one of two thermoplastic adhesive layers as a temporary blocking layer to block flow of molten thermoplastic adhesive from the other thermoplastic adhesive. While the second solid thermoplastic adhesive was illustrated above as the temporary blocking layer in a first separate step, the first thermoplastic adhesive layer can function as the temporary blocking layer within the same step by adjusting the relative melt indexes and melting points of the solid thermoplastic adhesives.

Referring back to FIG. 1, in general, upon the application of pressure and heat from the top side of the first outer layer 101, the HMI adhesive layer 104 melts and starts to penetrate the first outer layer 101 as the resulting flow of adhesive is initially blocked by the LMI adhesive layer 105 from flowing into the second porous layer 102. As heat and pressure continue to be applied, the LMI adhesive layer 105 subsequently melts, penetrating the second porous layer 102 and mixing with the flow of molten adhesive from the HMI adhesive layer 104. This automatically staged melting of the solid thermoplastic adhesives produces an improved bond between the first outer layer and the second outer layer without the application of excessive pressure. Therefore, excessive loss of thickness in the composite is avoided, and softness is preserved.

While illustrated with two continuous thermoplastic adhesive layers, in general, a plurality of thermoplastic adhesive layers is positioned between the two porous layers so that the plurality of thermoplastic adhesive layers at least partially overlap. In one embodiment, at least two sub-layers have the same melt index, which is different than the melt index of the other sub-layers. In one embodiment all layers have a different melt index. In one embodiment, a third thermoplastic adhesive layer is positioned between the two outer layers. The three thermoplastic adhesive layers overlap, and one of the three thermoplastic adhesive layers is located between two of the thermoplastic adhesive layers. In one exemplary embodiment, the second thermoplastic adhesive layer is positioned between the first thermoplastic adhesive layer and the third thermoplastic adhesive layer. The first thermoplastic adhesive layer has a first melt index, and the second thermoplastic adhesive layer has a second melt index. The third thermoplastic adhesive layer is selected to have a third melt index such that the second melt index is less than the first melt index and the third melt index. Therefore, the second thermoplastic adhesive layer can be used to temporarily block the flow of the first molten thermoplastic adhesive and the third molten thermoplastic adhesive, which are formed on either side of the second thermoplastic adhesive layer.

As illustrated in FIGS. 2 and 3, a first flat plate 108 and a second flat plate 110 are used to apply heat and pressure to the composite. In one embodiment, the plates, including the heated plates, are substituted with smooth rolls for continuous processing, and the temperatures of each plate or roll are chosen to be different. Choosing the different temperatures includes heating only one roll or plate. Alternatively, the pressure, either alone or in combination with the heat, is applied to the two outer layers to emboss a three-dimensional pattern into the two porous outer layers or the resulting composite. As illustrated in FIG. 4, in one embodiment, a first patterned plate 114 is used either in combination with a flat solid surface (not shown), with a recoverably compressible back-up surface, or, as illustrated, in combination with a second patterned plate or surface 116 to emboss the three-dimensional pattern.

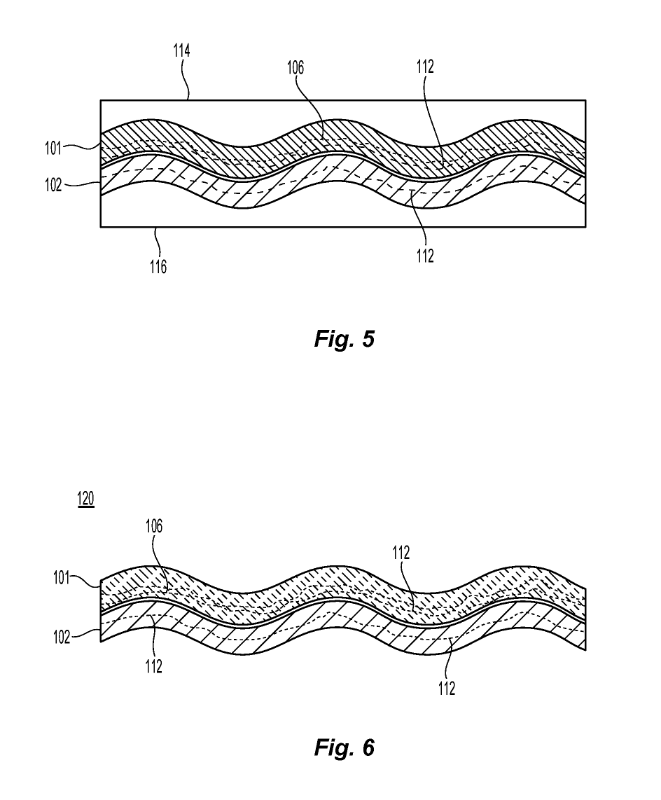

Referring to FIG. 5, the composite is placed between the first patterned plate 114 and the second patterned plate such that the first outer layer 101 is in contact with the first patterned plate and the second outer layer 102 is in contact with the second patterned plate. Heat and pressure are applied to the composite as described above with respect to the flat plates to initiate conversion of the first solid thermoplastic adhesive to the first molten thermoplastic adhesive 106 at a first time such that the first molten thermoplastic adhesive propagates under pressure a distance into only the first outer layer while being temporarily blocked by the second thermoplastic adhesive layer. As heat and pressure on the composite are maintained, the second thermoplastic adhesive layer is converted to the second molten thermoplastic adhesive 112 that flows a distance into the second outer layer. In addition to forcing the molten thermoplastic adhesives into the respective outer layers, the first and second patterned plates form a three-dimensional patterned composite 120 (FIG. 6). This pattern, e.g., a macro pattern, in the composite extends through the first and second porous layers. The composite pattern is formed concurrent with the bonding of the first and second outer layers using the molten thermoplastic adhesives.

In one embodiment, at least one of the outer layers is a textile fabric, and the plurality of thermoplastic layers can be placed between two textile fabric layers, between a textile layer and a non-textile layer or within a single textile fabric to control the flow of molten adhesive. Suitable textile fabrics include, but are not limited to, tufted fabrics, stitch-bonded fabrics, knit fabrics, woven fabrics, nonwoven fabrics, and needle-punched fabrics. In one embodiment, one of the layers to be bonded is a solid sheet, polymeric or non-polymeric, that is being attached to a porous fibrous layer.

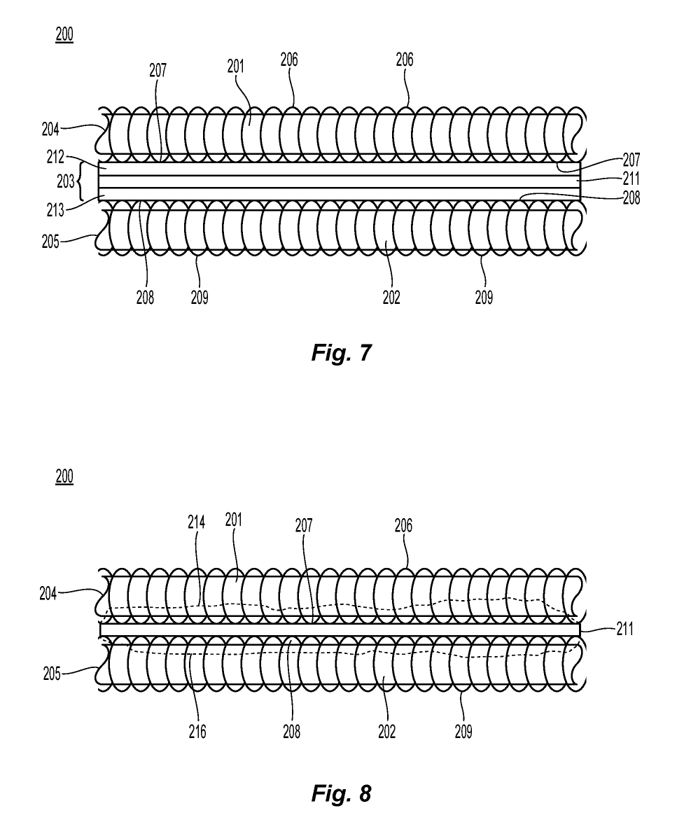

Referring now to FIG. 7, exemplary embodiments are directed to forming a composite 200 by attaching a first textile fabric 201 to a second textile fabric 202. An intermediate low-melting thermoplastic adhesive layer 203 is positioned between the first and second textile fabrics. The first textile fabric 201 includes a first inner structure 204, and the second textile fabric 202 includes a second inner structure 205. The first inner structure and second inner structure are porous and differ in at least one of porosity and receptiveness to adhesive. In one embodiment, the first inner structure has a first molten thermoplastic adhesive permeability, and the second inner structure has a second molten thermoplastic adhesive permeability. The first molten thermoplastic adhesive permeability is lower than the second molten thermoplastic adhesive permeability.

The first textile fabric 201 includes a plurality of first outer appended fibrous elements 206 and first inner appended fibrous elements 207 protruding through the first inner structure, and the second textile fabric 202 includes a plurality of second inner appended fibrous elements 208 and second outer appended fibrous elements 209 protruding through the second inner structure. Examples of protruding fibrous elements include, but are not limited to, yarns stitched or tufted through the inner structures and staple fibers or filaments needle-punched through the inner structures. In one embodiment, the appended fibrous elements are the underlaps or overlaps of a stitch-bonded fabric. In one embodiment, the appended fibrous elements are the pile tufts or back-laps of a tufted fabric. In one embodiment, the appended fibrous elements are the fibers or filaments of a needle-punched fabric.

As illustrated, the thermoplastic adhesive layer includes three separate layers or sub-layers that can be individually positioned between the textile fabrics or pre-bonded and positioned between the textile fabrics as a single solid thermoplastic adhesive layer. These sub-layers include a first thermoplastic adhesive layer 212, a second thermoplastic adhesive layer 211 and the third thermoplastic adhesive layer 213. The second thermoplastic adhesive layer is disposed between the first and third thermoplastic adhesive layers. In one embodiment, the first and third thermoplastic adhesives are HMI materials, and the second thermoplastic adhesive is a LMI material. In one embodiment, the melt indexes of the two HMI materials are individually selected to best suit the need of adhesive propagation into the adjacent layers 201 or 202.

Pressure and simultaneous heat are applied to the textile fabrics. Preferably, relatively lower pressures with simultaneous heat are applied to the composite illustrated in FIG. 7 to direct the optimum flow of adhesive into the inner appended fibrous elements 207, 208, and the inner structures 204, 205 provide surface stability to the surfaces 206, 209 and a strong bond between the first and second layers 201, 202. The use of LMI and HMI thermoplastic adhesive layers is particularly advantageous, achieving balanced flow into selected layers or elements using a high surface temperature and short periods of heat application. In one embodiment, these high surface temperatures are above the melting point of all thermoplastic adhesive layers. In one embodiment, this high surface temperature is applied using heated rolls and surface speeds above 5 to 10 meters per minute.

Suitable thermoplastics adhesive layers, including both LMI materials and HMI materials, include, but are not limited to, solid layers, interrupted non-continuous layers, perforated layers, layers of dry-applied powders, powders applied in a liquid suspension and pre-dried, solutions that solidify and subsequently melt and combinations thereof. In one embodiment, the plurality of sub-layers can be pre-bonded or pre-attached together prior to being placed within the layers of the textile fabric or between textile fabrics. In another embodiment, each sub-layer is placed separately or individually. Whether pre-bonded or layered in place, heat and pressure are subsequently applied to activate the adhesive sub-layers to inter-bond the surrounding surfaces and, when present, the fibrous elements projecting from the surfaces.

Referring to FIG. 8, the applied heat and pressure form a first molten thermoplastic adhesive 214 that penetrates the first inner appended fibrous elements 207 and first inner structure 204 of the first textile fabric to stabilize the first outer appended fibrous elements 206. The applied heat and pressure also form a third molten thermoplastic adhesive that penetrated the second inner appended fibrous elements 208 and the second inner structure 205 to stabilize the second outer appended fibrous elements 209. The first and second inner appended fibrous elements 207 and 208 are enveloped in adhesive as the first textile fabric 201 and the textile 202 are inter-bonded. The second thermoplastic adhesive layer temporarily blocks the flow of both the first molten thermoplastic adhesive and the third molten thermoplastic adhesive, keeping the two molten thermoplastic adhesives temporarily separated.

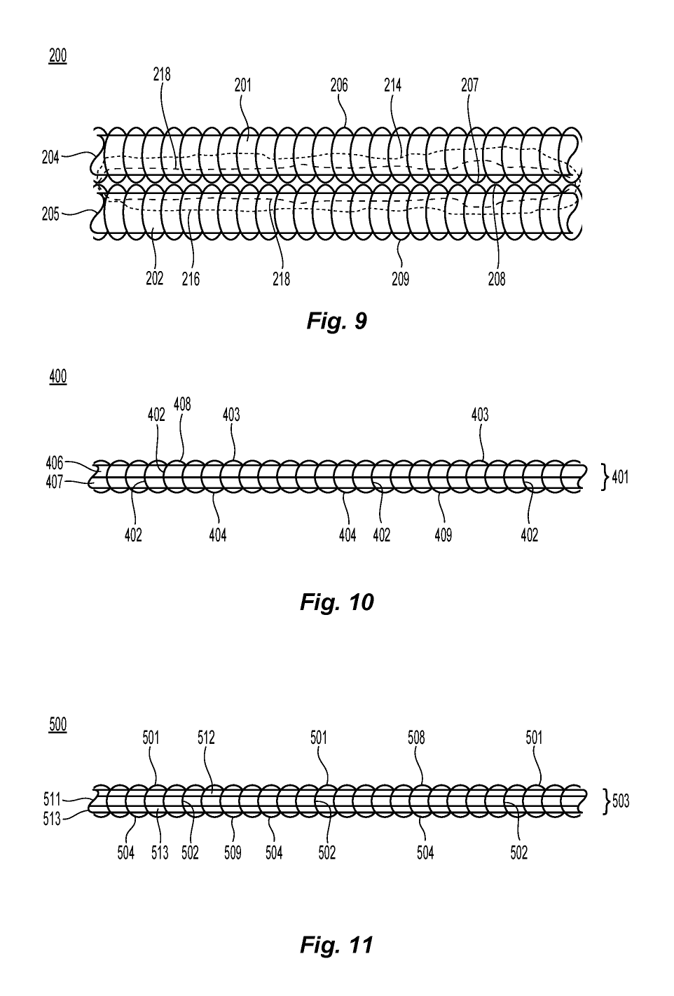

Referring now to FIG. 9, with continued application of heat and pressure, the second thermoplastic adhesive layer forms a second molten thermoplastic adhesive 218. The second molten thermoplastic adhesive penetrates the first inner appended fibrous elements 207, the first inner structure 204 of the first textile fabric, the second inner appended fibrous elements 208 and the second inner structure 205 to bond the first textile fabric to the second textile fabric and further stabilize the first and second outer appended fibrous elements. The first and third second molten thermoplastics can further penetrate into the fibrous elements and inner structures. The textile fabrics can be bonded together as a flat composite or can be bonded together with an embossed three-dimensional pattern as discussed herein.

As an alternative to placing the thermoplastic adhesives between the textile fabrics, a plurality of layers of thermoplastic adhesive can be placed within a given textile fabric and activated as described herein. The appended fibrous elements, e.g., the fibers or yarns, either surround the solid thermoplastic adhesives or penetrate the solid thermoplastics adhesives.

Suitable textile fabrics containing layers of thermoplastic adhesives that are penetrated with yarns include stich-bonded and tufted fabrics. Examples of textile fabrics where the layers of thermoplastic adhesive are penetrated by staple fibers or continuous filaments are needle-punched fabrics. As pressure and heat are applied the layers of thermoplastic adhesive containing LMI material initially stay intact and temporarily block the molten thermoplastic adhesive flow of the adjacent thermoplastic adhesives containing HMI material away from the more porous or more receptive adjacent elements or surfaces and towards the less receptive or less porous elements or surfaces. Directing and blocking of HMI molten thermoplastic adhesive continues until initiation or activation of the LMI molten thermoplastics adhesive. The LMI molten thermoplastic adhesive also flows into surrounding interstices to complement the function of the HMI molten thermoplastic adhesive.

In one embodiment, the HMI and LMI molten thermoplastic adhesives that are activated by heat and pressure applied to the surfaces of the textile fabric bond the layers of the fabric. Heat and pressure are applied using either a heated flat tool or a heated textured tool as described herein. In one embodiment, the textile fabric containing the layers of solid thermoplastic adhesives having multiple melt indexes and appended fibrous elements is pre-heated and subsequently subjected to pressure.

In one embodiment, the adhesives in the plurality of solid thermoplastic adhesives contain a single type of polymer. In another embodiment, the adhesives in the plurality of solid thermoplastics adhesives contain a plurality of different polymers. Suitable polymers include, but are not limited to, poly-olefins, polyethylenes, polypropylenes, polyesters, ethylene vinyl acetates (EVA's), polyolefines, polypropylenes, polyethylenes, co-polyesters, polyethylene terephthlate glycol (PETG), ethylene methyl acrylate (EMA), ethylene acrylic acid (EAA), ethylene vinyl acetate (EVA), ethylene methyl acrylate with maleic anhydride (1-28%), ethylene acrylic acid with maleic anhydride (1-28%) and ethylene vinyl acetate with maleic anhydride (1-28%).

An advantage achieved by using HMI layers in combination with LMI layers is that composite layers of blown films can be used. In one embodiment, the composite layers are formed with a base sub-layer of LMI to which skins of HMI are applied on one or both sides. These composite layers using blown films eliminate the need for separate, individual sub-layers that are separately stored and deployed. In addition, composite layers of blown films reduce the overall cost of the adhesive layer as the blown LMI sub-layers can be of a lower polymeric quality and lower cost. In addition, blown LMI sub-layers can be heat shrinkable, which facilitates pre-bulking of fabrics at low temperatures below the melting point of all components. Therefore, blown LMI sub-layers are ideal for pre-finishing fabrics in which the LMI sub-layers are contained and for subsequently securing the outer layers of the fabrics or attaching the fabrics to other layers. In addition, the blown LMI sub-layers allow three-dimensional formation, either simultaneously with bonding or subsequent to bonding, as these LMI sub-layers offer minimal resistance at temperatures above their melting points. Blown composite LMI and HMI films have a large range of thicknesses, e.g., in the range of from about 0.5 to about 10 or 15 thousands of an inch (roughly 100 to 3000 micron). This range of thicknesses facilitates an economical use of adhesives and avoids undesired composite fabric stiffness.

Referring now to FIG. 10, a textile fabric 400 is illustrated that contains a thermoplastic adhesive layer 401 enveloped by a plurality of appended fibrous elements 402 passing through the solid thermoplastic adhesive layer. The appended fibrous elements have top loops or ends 403 and bottom loops or ends 404 exposed on the top and bottom surfaces of the textile fabric. Examples of these textile fabrics include stitch-bonded fabrics, tufted fabrics and needle-punched fabrics containing a thermoplastic layer functioning as or replacing a stitching substrate in stitch-bonding, a primary backing in tufting and a reinforcing layer in needle-punching.

As illustrated in FIG. 10, the thermoplastic adhesive layer is a dual adhesive layer containing two sub-layers, a first thermoplastic adhesive layer 406 containing a HMI adhesive material and a second thermoplastic adhesive layer 407 containing a LMI adhesive material. The first thermoplastic adhesive layer, which is located above the second thermoplastic adhesive layer, is activated first using heat and pressure, and the resulting flow of first molten thermoplastic adhesive is directed to a desired top surface 408 using the second thermoplastic adhesive layer as a temporary blocking layer. The location of the LMI and HMI layers can be reversed to propel the adhesive towards the bottom surface 409 as desired. In one embodiment, the relative locations of the LMI and HMI layers are reversed to direct the flow of molten thermoplastic adhesive primarily toward either the technical front or the technical back of a stitch-bonded fabric. In one embodiment, a relatively low temperature is used to shrink and bulk the textile fabric by allowing the LMI adhesive material to shrink prior to the application of pressure and heat. In one embodiment, the HMI adhesive material is used to laminate the textile fabric to a separate textile or non-textile layer by forcing the HMI adhesive through the appended fibrous elements 402.

Referring to FIG. 11, a textile fabric 500 is illustrated that contains a thermoplastic adhesive layer 503 enveloped by a plurality of appended fibrous elements 502 passing through the solid thermoplastic adhesive layer. The fibrous elements have top loops or ends 501 and bottom loops or ends 504 exposed on the top and bottom surfaces of the fabric. Examples of suitable textile fabrics include stitch-bonded fabrics, tufted fabrics and needle-punched fabrics. In one embodiment, the textile fabrics contain a thermoplastic adhesive layer in combination with a stitching substrate, a tufting backing or a reinforcement layer. Alternatively, the textile fabrics include only the thermoplastic adhesive layer. Additional examples of textile fabrics include needle-punched fabrics containing a solid thermoplastic adhesive layer. To stabilize the exposed ends, the surface loops or both the exposed ends and surface loops, the thermoplastic adhesive layer 503 is activated.

In one embodiment, the thermoplastic adhesive layer 503 contains three layers or sub-layers. These three sub-layers include a first thermoplastic adhesive layer 512, a second thermoplastic adhesive layer 511 and the third thermoplastic adhesive layer 513. The second thermoplastic adhesive layer is disposed between the first and third thermoplastic adhesive layers. In one embodiment, the first and third thermoplastic adhesives are HMI materials, and the second thermoplastic adhesive is a LMI material. The flow of molten thermoplastic adhesive from the first and third thermoplastic adhesive layers is initially directed to the top outer surfaces 508 and bottom outer surface 509 to different degrees depending upon the need to secure one surface more than the other surface. The resulting bonded composite can be embossed to produce a 3-D embossed composite as illustrated, for example, in FIG. 6. Embossing with the 3-D pattern can be conducted during the lamination and bonding process or after lamination and bonding. When 3-D embossing is conducted after lamination and bonding, excessive flow of melted adhesive outwards is avoided, preventing substantial losses of bulk and softness.

As in the case of a dual adhesive layer, the textile fabric of FIG. 11 can be preheated at a temperature below the melting point of the LMI sub-layer to shrink the layer and bulk the fabric prior to the application of pressure and heat to propel the outer sub-layers outwards. Similarly, the textile fabric can be simultaneously attached to a separate textile or non-textile structure in the process, with or without simultaneous embossing.

The activation of thermoplastic adhesive layers in the fabrics illustrated in FIGS. 10 and 11 can be performed with heated embossing tools to inter-bond the fabric or fabric layers and to produce a three-dimensional fabric simultaneously. Suitable heated embossing tools are illustrated in FIG. 4. In one embodiment, embossing is performed after the layers are inter-bonded using flat or smooth-surfaced tooling.

The foregoing written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for adhesively bonding two layers, the method comprising:
positioning two thermoplastic adhesive layers between two outer layers, the two thermoplastic adhesive layers at least partially overlapping;
initiating conversion of each thermoplastic adhesive layer to molten thermoplastic adhesive at a distinct time using at least one of heat and pressure applied to the outer layers to drive the molten thermoplastic adhesives into at least one of the outer layers; and
using one of the two thermoplastic adhesive layers to block flow of molten thermoplastic adhesive temporarily.

2. The method of claim 1, wherein:
positioning two thermoplastic adhesive layers comprises positioning a first thermoplastic adhesive layer and a second thermoplastic adhesive layer between two outer layers;
initiating conversion comprises:
initiating conversion of the first thermoplastic adhesive layer to a first molten thermoplastic adhesive at a first time; and
initiating conversion of the second thermoplastic adhesive layer to a second molten thermoplastic adhesive at a second time, the second time distinct from and subsequent to the first time; and
using one of the two thermoplastic adhesive layers to block flow comprises using the second thermoplastic adhesive layer to block flow of the first molten adhesive from the first time to the second time.

3. The method of claim 1, wherein positioning the two thermoplastic adhesive layers comprises positioning a blown thermoplastic film between the two outer layers, the two thermoplastic adhesive layers comprising sub-layers in the blown thermoplastic film.

4. The method of claim 1, wherein the two thermoplastic adhesive layers comprise melting points lower than melting points of the two outer layers.

5. The method of claim 1, wherein:
the two outer layers comprise a first outer layer comprising a first molten thermoplastic adhesive permeability and a second outer layer comprising a second molten thermoplastic adhesive permeability, the first molten thermoplastic adhesive permeability lower than the second molten thermoplastic adhesive permeability; and
using one of the two thermoplastic adhesive layers to block flow comprises using one of the two thermoplastic adhesive layers to block flow of molten thermoplastic adhesive into the second outer layer temporarily.

6. The method of claim 1, wherein the two thermoplastic adhesive layers comprise a first thermoplastic adhesive layer comprising a first melt index and a second thermoplastic adhesive layer comprising a second melt index, the first melt index higher than the second melt index.

7. The method of claim 6, wherein the second melt index is less than about 1 g/10 min.

8. The method of claim 6 wherein the second melt index is less than 0.5 g/10 min.

9. The method of claim 6, wherein a ratio between the first melt index and the second melt index is at least 10/1.

10. The method of claim 6, wherein a ratio between the first melt index and the second melt index is at least 5/1.

11. The method of claim 6, wherein using one of the two thermoplastic adhesive layers to block flow comprises using the second thermoplastic adhesive layer to block flow of molten thermoplastic adhesive from the first thermoplastic adhesive layer temporarily.

12. The method of claim 1, wherein each one of the two thermoplastic adhesive layers comprises poly-olefin, polyethylene, polypropylene, polyester, ethylene vinyl acetate, co-polyester, polyethylene terephthlate glycol, ethylene methyl acrylate, ethylene acrylic acid, ethylene vinyl acetate, ethylene methyl acrylate with maleic anhydride, ethylene acrylic acid with maleic anhydride, ethylene vinyl acetate with maleic anhydride or combinations thereof.

13. The method of claim 1, wherein the method further comprises positioning a third thermoplastic adhesive layer between the two outer layers, the three thermoplastic adhesive layers overlapping, and one of the three thermoplastic adhesive layers located between two of the thermoplastic adhesive layers.

14. The method of claim 13, wherein positioning the thermoplastic adhesive layers further comprises positioning the second thermoplastic adhesive layer between the first thermoplastic adhesive layer and the third thermoplastic adhesive layer, the first thermoplastic adhesive layer having a first melt index, the second thermoplastic adhesive layer having a second melt index and the third thermoplastic adhesive layer having a third melt index, the second melt index less than the first melt index and the third melt index.

15. The method of claim 1, wherein the method further comprises bonding the two thermoplastic adhesive layers together before positioning the two thermoplastic adhesive layers between the two outer layers.

16. The method of claim 1, wherein the method further comprises using pressure applied to the two outer layers to emboss a three-dimensional pattern into the two outer layers.

17. A method for stabilizing a textile fabric, the method comprising:
positioning two thermoplastic adhesive layers within a textile fabric comprising fibrous elements, the two thermoplastic adhesive layers at least partially overlapping;
initiating conversion of each thermoplastic adhesive layer to molten thermoplastic adhesive at a distinct time using at least one of heat and pressure applied to the textile fabric to drive the molten thermoplastic adhesives through the fibrous elements; and
using one of the two thermoplastic adhesive layers to block flow of molten thermoplastic adhesive temporarily.

18. The method of claim 17, wherein the two thermoplastic adhesive layers each comprise a melting point and at least one thermoplastic adhesive layer is heat shrinkable at a heat shrink temperature that is lower than the melting point of the at least one thermoplastic adhesive.

19. The method of claim 17, wherein:
positioning the two thermoplastic adhesive layers comprises positioning a first thermoplastic adhesive layer and a second thermoplastic adhesive layer within the textile fabric;
initiating conversion comprises:
initiating conversion of the first thermoplastic adhesive layer to a first molten thermoplastic adhesive at a first time; and
initiating conversion of the second thermoplastic adhesive layer to a second molten thermoplastic adhesive at a second time, the second time distinct from and subsequent to the first time; and
using one of the two thermoplastic adhesive layers to block flow comprises using the second thermoplastic adhesive layer to block flow of the first molten adhesive from the first time to the second time.

20. The method of claim 17, wherein:
the two thermoplastic adhesive layers comprise a first thermoplastic adhesive layer and a second thermoplastic adhesive layer; and
the method further comprises positioning a third thermoplastic adhesive layer within the textile fabric such that the second thermoplastic adhesive layer is between the first thermoplastic adhesive layer and the third thermoplastic adhesive layer, the first thermoplastic adhesive layer having a first melt index, the second thermoplastic adhesive layer having a second melt index and the third thermoplastic adhesive layer having a third melt index, the first melt index and the third melt index at least 5 times greater than the second melt index.

21. The method of claim 17, wherein the method further comprises bonding the two thermoplastic adhesive layers together before positioning the two thermoplastic adhesive layers within the textile fabric.
